(19) United States
(12) Patent Application Publication
(10) Pub. No.: US 2006/0189780 A1
(43) Pub. Date: Aug. 24, 2006

(54) Reinforced polyurethane/urea elastomers and molded articles produced therefrom

(75) Inventors: Peter Haas, Haan (DE); Hans-Detlef Arntz, Lohmar (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/352,549

(22) Filed: Feb. 13, 2006

(30) Foreign Application Priority Data
Feb. 18, 2005 (DE) 102005007470.7

(51) Int. Cl. C08G 18/00

(52) U.S. Cl. 528/44

(57) ABSTRACT

Reinforced polyurethane/urea elastomers with a specified proportion of urea groups and a specified proportion of urethane groups are produced from an isocyanate-reactive component satisfying specified compositional requirements and an isocyanate-terminated prepolymer produced from specified materials. Two-dimensional polyurethane molded articles produced from these reinforced elastomers are characterized by improved toughness and improved shrinkage characteristics. Such molded articles are particularly useful for making automobile components.

### BACKGROUND OF THE INVENTION

The present invention relates to reinforced polyurethane/urea elastomers having a specified urea group content and a specified urethane group content and to two-dimensional molded polyurethane articles having improved toughness and improved shrinkage characteristics produced from these elastomers.

The preparation of polyurethane/urea elastomers by reacting NCO semi-prepolymers with mixtures of aromatic amines and high molecular weight hydroxyl or amino group-containing compounds is well-known and is described, for example, in EP-A 656 379. These polyurethane elastomers exhibit improved mechanical characteristics. In order to achieve certain mechanical characteristics for molded articles produced therefrom, reinforcement substances have to be added to the reaction components to improve the thermo-mechanical characteristics and increase the flexural modulus of elasticity. However, in the event of repeated thermal stressing of these molded items, which can occur for example as a result of several lacquer curing steps, it is observed that the shrinkage values of such molded parts can be impaired.

The lowest possible shrinkage value, preferably constant shrinkage, is desirable, however, even in the event of repeated thermal post-treatment procedures, in order to be able to accurately produce parts. Another important characteristic is the flexural strength of the parts during demolding.

### SUMMARY OF THE INVENTION

Thus, the object of the present invention was to provide polyurethane elastomrers which have low shrinkage or post-shrinkage under considerable thermal stress and which exhibit high toughness during demolding.

Surprisingly, it has now been found that polyurethane/urea elastomers having specified urea and urethane group contents into which reinforcement substances have been incorporated can be used for the production of tough, two-dimensional molded items having problem-free behavior with regard to dimensional stability (even under considerable thermal stress as a result of post-treatment) and have overall low shrinkage values.

### DETAILED DESCRIPTION OF THE INVENTION

The present invention provides polyurethane/urea elastomers into which reinforcement substances have been incorporated having a urea group content of from about 70 to about 95 mol. % (based on total mol % of reacted NCO groups) and a urethane group content of from about 5 to about 30 mol. % (based on total mol % of reacted NCO groups), obtainable by reacting a reaction mixture comprising an A-component which includes:
A1) at least one aromatic diamine which has an alkyl substituent in at least one ortho-position to each of the amino groups,
A2) an aliphatic reaction component which includes at least one polyether polyol which (i) contains hydroxyl and/or primary amino groups; (ii) has a number average molecular weight of from 500 to about 18,000; (iii) has a functionality of from 2 to 8; (iv) has an ethylene oxide content of from 40 to 100% by weight; and (v) an alklyoxirane content of from 0 to 60% by weight,
A3) optionally, an aliphatic amine,
A4) at least one reinforcement material and
A5) optionally, one or more catalysts and/or additives,
A6) optionally, a metal salt mold release agent
and a B-component comprising a prepolymer produced from
B1) a polyisocyanate component comprising a liquefied polyisocyanate or polyisocyanate mixture from the diphenylmethane series and
B2) a polyol component with a number average molecular weight of from 500 to 18,000 comprising at least one polyether polyol which (i) has a functionality of from 2 to 8; (ii) an ethylene oxide content of less than 40% by weight; (iii) an alkyloxirane content of greater than 60% by weight; and (iv) optionally contains an organic filler,

in amounts such that the A-component and the B-component are reacted in a stoichiometric ratio by weight such that (i) the isocyanate index of the elastomers obtained is in the range of from 80 to 120 and (ii) polyol component B2) introduced via the B-component represents 10 to 90 mol. % of the urethane content of the product.

Reinforced polyurethane/urea elastomers with a urea, share of 75 to 95 mol. % and a urethane share of 5 to 25 mol. %, with respect to mol. % of NCO equivalent are preferred.

The invention also provides polyurethane articles/parts, made from the polyurethane/urea elastomers of the present invention, which are characterized by good dimensional stability after thermal treatment and high fracture resistance after demolding.

Furthermore, it is preferred that the A-component and the B-component be reacted in a ratio by weight such that the isocyanate index of the elastomers obtained is preferably in the range from 90 to 115 and the polyol component B2) introduced via the B-component represents 30 to 85% of the urethane content.

Preferred reinforcement substances A4) include those reinforcement substances which are of an inorganic nature and have a platelet and/or needle structure. These are, in particular, silicates of metals from groups IIA and IIIA in the Periodic System, such as calcium silicate of the wollastonite type and aluminum silicate of the mica or kaolin type. Such siliceous reinforcement substances are well-known under the names group, ring, chain or ribbon silicates, e.g. as described in Hollemann-Wiberg, W. de Gruyter Verlag (1985), 768 to 778.

These reinforcement substances have a diameter or sheet depth or thickness of from 2 to 30 μm and a longitudinal extent of from 10 to 600 μm and have a length/diameter quotient which is in the range of from 5:1 to 35:1, preferably, from 7:1 to 30:1. The diameter of spherical fractions is from 50 to 150 μm, preferably, from 20 to 100 μm.

The reinforcement substances mentioned are normally added in amounts of from 10 to 35 wt. %, preferably 10 to 30 wt. %, with respect to the total weight of components A and B.

Suitable compounds for use as component A1) are aromatic diamines which have an alkyl substituent in at least one ortho-position to each of the amino groups and which have a molecular weight of 122 to 400. Particularly preferred are those aromatic diamines which have at least one alkyl substituent in the ortho-position to the first amino group and two alkyl substituents in the ortho-position to the second amino group, each having 1 to 4, preferably 1 to 3, carbon atoms. Very particularly preferred are those which have ethyl, n-propyl and/or iso-propyl substituents in at least one ortho-position to each of the amino groups and optionally methyl substituents in other ortho-positions to the amino groups. Examples of these types of diamines are: 2,4-diaminomesitylene; 1,3,5-triethyl-2,4-diaminobenzene; and technical-grade mixtures of this with 1-methyl-3,5-diethyl-2,6-diaminobenzene; or 3,5,3′,5′-tetraisopropyl-4,4′-diaminodiphenylmethane. Obviously, mixtures of these with each other may also be used. Component A1) is most preferably 1-methyl-3,5-diethyl-2,4-diaminobenzene or technical-grade mixtures of this with 1-methyl-3,5-diethyl-2,6-diaminobenzene (DETDA).

Component A2) includes at least one polyether polyol with aliphatically bonded hydroxyl and/or primary amino groups having a number average molecular weight of from 500 to 18,000, preferably from 1000 to 16,000, more preferably from 1500 to 15,000. Component A2) has the previously mentioned functionalities. The polyether polyols may be prepared in any known manner by the alkoxylation of starter molecules or mixtures of these with appropriate functionalities. Ethylene oxide in particular is used for alkoxylation purposes, as well as secondary alkyloxiranes such as propylene oxide. Suitable starters or starter mixtures are sucroses, sorbitol, pentaerythritol, glycerine, trimethylenepropane, propylene glycol and water. Those polyether polyols with up to 50%, preferably up to 70%, most preferably, 100% all of the hydroxyl groups being primary hydroxyl groups are particularly suitable for use in the practice of the present invention. Also suitable here are those polyether polyols which optionally contain organic fillers in dispersed form. These dispersed fillers are, for example, vinyl polymers which are produced by polymerization of acrylonitrile and styrene in polyether polyols as a reaction medium (See, e.g., U.S. Pat. Nos. 3,383,351; 3,304,273; 3,523,093; 3,110,695; and DE-PS 11 52 536.), or polyureas or polyhydrazides such as those produced from organic diisocyanates and diamines or hydrazine by a polyaddition reaction in polyether polyols as a reaction medium (See, e.g., DE-PS. 12 60 142; DE-OS 24 23 984; 25 19 004; 25 13 815; 25 50 833; 25 50 862; 26 33 293; and 25 50 796.).

Such polyethers are described, for example, in Kunststoffhandbuch 7, Becker/Braun, Carl Hanser Verlag, 3rd edition, 1993.

Furthermore, polyether polyols with primary amino groups may be used as component A2). Such polyether polyols are described in EP-A 219 035 and are known as ATPE (amino-terminated polyethers).

Particularly suitable as component A3) are those sold under the name Jeffamine® by Texaco, which are built up from α,ω-diaminopolypropylene glycols.

Any of the known catalysts for the urethane and urea reaction may be used as component A5). Such catalysts include tertiary amines and/or tin(II) or tin(IV) salts of higher carboxylic acids. Further additives which may be used are stabilizers, such as the well-known polyether siloxanes, and/or mold release agents. Known catalysts or additives are described, for example, in chapter 3.4 of Kunststoffhandbuch 7, Polyurethane, Carl Hanser Verlag (1993), p. 95 to 119, and may be used in conventional amounts.

Metal salts such as zinc stearate, zinc palmitate, zinc oleate, and magnesium stearate may be used as component A6). These are preferably dissolved and used in component A3).

The so-called B-component is an NCO-terminated prepolymer based on polyisocyanate component B1) and polyol component B2) and has a NCO content of from 8 to 26 wt. %, preferably from 12 to 25 wt. %.

Polyisocyanates B1) include polyisocyanates or polyisocyanate mixtures from the diphenylmethane series which have optionally been liquefied by chemical modification. The expression “polyisocyanate from the diphenylmethane series” is the generic term for all polyisocyanates like those formed during phosgenation of aniline/formaldehyde condensates and present in the phosgenation products as individual components. The expression “polyisocyanate mixture” from the diphenylmethane series” is any mixture of polyisocyanates from the diphenylmethane series, i.e. for example the phosgenation products mentioned above, the mixtures in which these types of mixtures are obtained as the distillate or the distillation residue during separation by distillation and for any mixtures of polyisocyanates from the diphenylmethane series.

Typical examples of suitable polyisocyanates B1) are 4,4′-diisocyanatodiphenylmethane, its mixtures with 2,2′- and in particular 2,4′-diisocyanatodiphenylmethane, mixtures of these diisocyanatodiphenylmethane isomers and their higher homologues, such as those produced during the phosgenation of aniline/formaldehyde condensates, di- and/or polyisocyanates modified by partial carbodiimidization of the isocyanate groups in the di- and/or polyisocyanates mentioned or any mixture of these types of polyisocyanates.

Polyether polyols or mixtures of these types of polyhydroxyl compounds are suitable as component B2). For example, polyether polyols satisfying the functionality, molecular weight, ethylene oxide content, and alklyoxirane content requirements specified above and which optionally contain organic fillers in dispersed form are suitable. The dispersed fillers may be, for example, vinyl polymers such as those produced by polymerization of acrylonitrile and styrene in the polyether polyol as a reaction medium (See, e.g., U.S. Pat. Nos. 3,383,351; 3,304,273; 3,523,093; 3,110,695; and DE-PS 11 52 536), or polyureas or polyhydrazides such as are produced from organic diisocyanates and diamines or hydrazine by a polyaddition reaction in the polyether polyols as a reaction medium (See, e.g., DE-PS 12 60 142; DE-OS 24 23 984; 25 19 004; 25 13 815; 25 50 833; 25 50 862; 26 33 293; or 25 50 796.). Basically, polyether polyols suitable for use as component B2) are of the type already mentioned under A2), provided they correspond to the last mentioned characteristics.

Polyol component B2) has an average molecular weight of preferably 1000 to 16,000, in particular 2000 to 16,000, and a hydroxyl functionality of from 2 to 8, preferably from 3 to 7.

To prepare NCO semi-prepolymers B), components B1) and B2) are preferably reacted in a ratio by weight (NCO excess) such that NCO semi-prepolymers with the NCO content mentioned above are obtained. This particular reaction is performed in general within the temperature range of from 25 to 100° C. When preparing the NCO semi-prepolymers, it is preferred that the total amount of polyisocyanate component B 1) be reacted with the total amount of component B2) provided to prepare the NCO semi-prepolymers.

Elastomers in accordance with the present invention may be produced by using the well-known reaction injection molding technique (RIM process), as is described, for example, in DE-AS 2 622 951 (U.S. Pat. No. 4,218,543) or DE-OS 39 14 718. The ratio by weight of components A) and B) in this case corresponds to the stoichiometric ratio with a NCO index of 80 to 120. The amount of reaction mixture introduced into the mold is generally selected to be such that the molded article will have a density of at least 0.8, preferably from 1.0 to 1.4 g/cm³. The density of the resulting molded article obviously depends to a high degree on the type and proportion by weight of the filler used. In general, molded articles produced in accordance with the invention are microcellular elastomers (i.e., they are not genuine expanded materials with a foam structure visible to the naked eye). This means that the optional organic blowing agents exert less of a true blowing agent function and function more as a flow improver.

The initial temperature of the reaction mixture of components A) and B) introduced into the mold is generally from 20 to 80° C., preferably from 30 to 70° C. The temperature of the mold is generally from 30 to 130° C., preferably from 40 to 80° C. Suitable molds include any of those known to those skilled in the art, preferably molds made of aluminum or steel or metal-sprayed epoxide molds. To improve the demolding characteristics, the internal walls of the mold being used are optionally coated with nay of the known external mold release agents.

The molded articles/items being produced in the mold may generally be demolded after a mold dwell time of from 5 to 180 seconds. Conditioning at a temperature of about 60 to 180° C. for a period of 30 to 120 minutes may optionally follow demolding.

The reinforced polyurethane/urea elastomers of the present invention are useful for the production of molded articles/parts by any of the known processes.

The preferably two-dimensional molded articles produced in accordance with the present invention are suitable in particular for producing lacquered components for vehicles, e.g. flexible aprons for cars or flexible bodywork elements such as doors and tailgates or mudguards for cars.

The invention is intended to be described in more detail by means of the following examples.

### EXAMPLES

Starting Materials

Semi-Prepolymer 1

976 parts by wt. of 4,4′-diisocyanatodiphenylmethane reacted at 90° C. with 724 parts by wt. of Polyether Polyol 2 having a functionality of 6.

NCO content after 2 hours: 18.1%

Semi-Prepolymer 2

1121 parts by wt. of 4,4′-diisocyanatodiphenylmethane reacted at 90° C. with 779 parts by wt. of Polyether Polyol 1 having a functionality of 3.

NCO content after 2 hours: 18.2%

Polyol 1

A polyether polyol with an OH value of 37, prepared by alkoxylation of glycerine as a starter in the ratio of 72 wt. % of ethylene oxide and 18 wt. % of propylene oxide, with mainly primary OH groups.

Polyol 2

A polyether polyol with an OH value of 28, prepared by propoxylation of the hexafunctional sorbitol with propylene oxide followed by ethoxylation in the ratio 83:17, with mainly primary OH groups.

DETDA

A mixture of 80 wt. % of 1-methyl-3,5-diethyl-2,4-diaminobenzene and 20 wt. % of 1-methyl-3,5-diethyl-2,6-diaminobenzene.

DABCO 33 LV

A solution of 1,4-diazabicyclo[2.2.2]octane in -dipropylene glycol (from Air products)

Jeffamine D400

Polyoxypropylene diamine (from Texaco)

DBTDL

Dibutyltin dilaurate

Wollastonite

Tremin 939-955 from Quarzwerke, Frechen

Processing of the formulations described in the following was performed by the reaction injection molding technique. The A- and B-components were forced into a heated multi-plate mold with the dimensions 300×200×3 mm, at a mold temperature of 60° C., via a restrictor bar gate in high-pressure metering equipment, after intensive mixing in a positive-control mixing head.

The temperature of the A-component was 60° C., the temperature of the B-component was 50° C. The product was demolded after 30 seconds.

The mechanical values were measured after conditioning in a circulating air drying cabinet (45 min at 160° C.) followed by storage (24 hours).

Before each run, the mold was treated with the mold release agent commercially available under the name Acmos 36-5130 from Acmos Bremen.

The data relating to amounts reported in the table are given in parts by weight.

TABLE 1

| | Example | |
|---|---|---|
| | | 2 |
| | 1 | (comparison) |
| Polyol 1 | 52.5 | — |
| Polyol 2 | — | 52.5 |
| DETDA | 42.0 | 42.0 |
| Zn stearate | 2 | 2 |
| Jeffamine D400 | 3 | 3 |
| Dabco 33 LV | 0.3 | 0.3 |
| DBTDL | 0.2 | 0.2 |
| Sum of A-components | 100.0 | 100.0 |
| Wollastonite | 64.2 | 63.6 |
| Semi-prepolymer 1 | 127.6 | — |
| Semi-prepolymer 2 | — | 125.5 |
| Wollastonite in the elastomer [wt. %] | 22 | 22 |
| Index | 105 | 105 |
| Fractures on bending manually | no | yes |
| Stepped strength of bent sheet | | |
| Number of steps without fracturing | 8* | 0 |
| a) immediately after demolding | >10 | >10 |
| b) after conditioning at 160° C./45 min | 0.36/1.0 | 0.58/1.1 |
| Shrinkage value (l/q) [%]: | 0.51/1.3 | 0.67/1.3 |
| at Room Temperature | 0.53/1.3 | 0.87/1.4 |
| after 1st conditioning (160° C./45 min) | 160 | 110 |
| after 2nd conditioning (160° C./45 min) | 2100 | 1680 |
| Elongation at break DIN 53504 [%] | 185 | 175 |
| Flexural modulus ASTM 790 [MPa] | | |
| HDT ISO 75-1/75-2 [° C.] | | |

*slight cracks appeared during 9th step
l = in longitudinal direction
q = transverse to longitudinal direction

Polyurethane/urea elastomer 1 showed, when compared with elastomer 2 (comparison trial) important advantages with regard to its mechanical characteristics. For example, the stepped strength even during demolding of the test specimen in the non-conditioned state was much better than that of the comparison elastomer of Example 2. Furthermore, the only slight change in shrinkage on repeated conditioning at 160° C. for 45 minutes is considered quite advantageous. In the comparison trial, the change was 0.2% in the longitudinal direction; i.e. a 1 m long molded part was 2 mm shorter after repeated conditioning.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A reinforced polyurethane/urea having a urea group content of from about 70 to about 95 mol. % (based on total mol % of reacted NCO groups) and a urethane group content of from about 5 to about 30 mol. % (based on total mol % of reacted NCO groups) comprising. the reaction product of a reaction mixture compnsing:
(1) an A-component comprising:
A1) at least one aromatic diamine which has an alkyl substituent in at least one ortho-position to each of the amino groups,
A2) an aliphatic reaction component which includes at least one polyether polyol which (i) contains hydroxyl and/or primary amino groups; (ii) has a number average molecular weight of from 500 to about 18,000; (iii) has a functionality of from 2 to 8; (iv) has an ethylene oxide content of from 40 to 100% by weight; and (v) an alklyoxirane content of from 0 to 60% by weight,
A3) optionally, an aliphatic amine,
A4) at least one reinforcement material and
A5) optionally, one or more catalysts and/or additives,
A6) optionally, a metal salt mold release agent and
(2) a B-component comprising a prepolymer produced from
B1) a polyisocyanate component comprising a liquefied polyisocyanate or polyisocyanate mixture from the diphenylmethane series and
B2) a polyol component with a number average molecular weight of from 500 to 18,000 comprising at least one polyether polyol which (i) has a functionality of from 2 to 8; (ii) an ethylene oxide content of less than 40% by weight; (iii) an alkyloxirane content of greater than 60% by weight; and (iv) optionally contains an organic filler,
in amounts such that (i) the elastomer has an isocyanate index of from 80 to 120 and (ii) polyol component B2) introduced via the B-component represents 10 to 90 mol. % of the urethane content of the elastomer.

2. A molded article produced from the reinforced polyurethane/urea elastomer of claim 1.

3. A lacquered automobile door produced from the molded article of claim 2.
